(19) United States
(12) Patent Application Publication
(10) Pub. No.: US 2016/0088696 A1
(43) Pub. Date: Mar. 24, 2016

(54) SYSTEM FOR CONTROLLING CONTROL TARGET UNITS, METHOD OF CONTROLLING CONTROL TARGET UNITS, AND RECORDING MEDIUM

(71) Applicants: Osamu KIZAKI, Saitama (JP); Nobuhiro MORITA, Tokyo (JP); Yuji OHUE, Kanagawa (JP); Akiyoshi NAKAI, Kanagawa (JP); Kenta YAMAGUCHI, Kanagawa (JP); Toshihiro ISOZAKI, Kanagawa (JP)

(72) Inventors: Osamu KIZAKI, Saitama (JP); Nobuhiro MORITA, Tokyo (JP); Yuji OHUE, Kanagawa (JP); Akiyoshi NAKAI, Kanagawa (JP); Kenta YAMAGUCHI, Kanagawa (JP); Toshihiro ISOZAKI, Kanagawa (JP)

(21) Appl. No.: 14/857,397

(22) Filed: Sep. 17, 2015

(30) Foreign Application Priority Data
Sep. 19, 2014 (JP) 2014-191111
Sep. 10, 2015 (JP) 2015-178270

(51) Int. Cl. H05B 33/08; H05B 37/02

(52) U.S. Cl. CPC H05B 33/0842; H05B 37/0218; H05B 37/0272

(57) ABSTRACT

A system for controlling one or more control target units in a predetermined space includes a first control rule management unit managing heat source existence information and a control item of the control target unit associating with each other, a second control rule management unit managing position information indicating a position of the area and adjustment information associating with each other, a receiver receiving detection data indicating a temperature, a first generator generating heat source data including heat source existence information, a second generator obtaining a control item of the control target using the heat source existence information from the first control rule management unit, obtaining adjustment information from the second control rule management unit, and generating control data indicating a modified control item, and a transmitter transferring the control data generated by the second generator to one or more apparatuses each controlling the control target unit.

### CROSS-REFERENCE TO RELATED APPLICATION

This patent application is based on and claims priority pursuant to 35 U.S.C. §119(a) to Japanese Patent Application Nos. 2014-191111, filed on Sep. 19, 2014 and 2015-178270, filed on Sep. 10, 2015 in the Japan Patent Office, the entire disclosures of which are hereby incorporated by reference herein.

### BACKGROUND

1. Technical Field

The present invention relates to a system for controlling control target units, a method of controlling control target units, and a non-transitory recording medium storing a program.

2. Background Art

In partitioning space such as an office into multiple areas, some areas are occupied by human while other areas are not occupied by human. In occupied areas, it is desired to turn on a lighting apparatus for increased productivity. By contrast, it is not necessary to turn on lighting apparatuses in unoccupied areas, or even preferable to turn off lighting apparatuses to reduce waste of electric power. A technology that detects presence of human using a temperature distribution sensor with a thermopile and saves energy by turning off lighting apparatuses in unoccupied areas is known.

### SUMMARY

A novel system for controlling one or more control target units in a predetermined space that includes a first control rule management unit that manages heat source existence information indicating whether a heat source exists at a specific area in the predetermined space and a control item of the control target unit associating with each other, a second control rule management unit that manages, for each area of the predetermined space, position information indicating a position of the area and adjustment information to be used for adjusting the control item associating with each other, a receiver that receives detection data indicating a temperature at each of multiple areas in the predetermined space, a first generator that generates heat source data including heat source existence information indicating whether a heat source exists for each of the multiple areas based on the detection data, a second generator that obtains a control item of the control target using the heat source existence information for each of the multiple areas from the first control rule management unit, obtains adjustment information for each of the multiple areas using position information of each area from the second control rule management unit, and generates control data indicating a modified control item for each of the multiple areas based on the obtained control item and the obtained adjustment information, and a transmitter that transfers the control data generated by the second generator to one or more apparatuses each controlling the control target unit.

Further example embodiments of the present invention provide a method of controlling one or more control target units in a predetermined space and a non-transitory recording medium storing a program.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a schematic diagram illustrating a configuration of a position management system as an embodiment of the present invention.

FIG. 2 is a diagram illustrating a LED lighting apparatus as an example of a device to be controlled as an embodiment of the present invention.

FIG. 3 is a diagram illustrating a hardware configuration of a detection device as an embodiment of the present invention.

FIG. 4 is a diagram illustrating a hardware configuration of a position information management system as an embodiment of the present invention.

FIG. 5 is a diagram illustrating a functional configuration of the position management system of FIG. 1 as an embodiment of the present invention.

FIG. 6A is a conceptual diagram illustrating layout information of a control target device, and FIG. 6B is a conceptual diagram illustrating layout information of an office room.

FIG. 7 is a conceptual diagram illustrating a control rule management table as an embodiment of the present invention.

FIG. 8 is a sequence diagram illustrating operation performed by the position management system as an embodiment of the present invention.

FIG. 9A is a conceptual diagram illustrating temperature distribution, and FIG. 9B is a diagram illustrating heat source data that indicates whether a heat source exists.

FIG. 10 is a diagram illustrating heat source data that indicates whether a heat source exists for all areas in an office room.

FIG. 11 is a conceptual diagram illustrating a control rule management table as an embodiment of the present invention.

FIG. 12 is a flowchart illustrating a process of calculating a light level factor for each control target device as an embodiment of the present invention.

FIG. 13 is a conceptual diagram illustrating a control rule management table as another embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

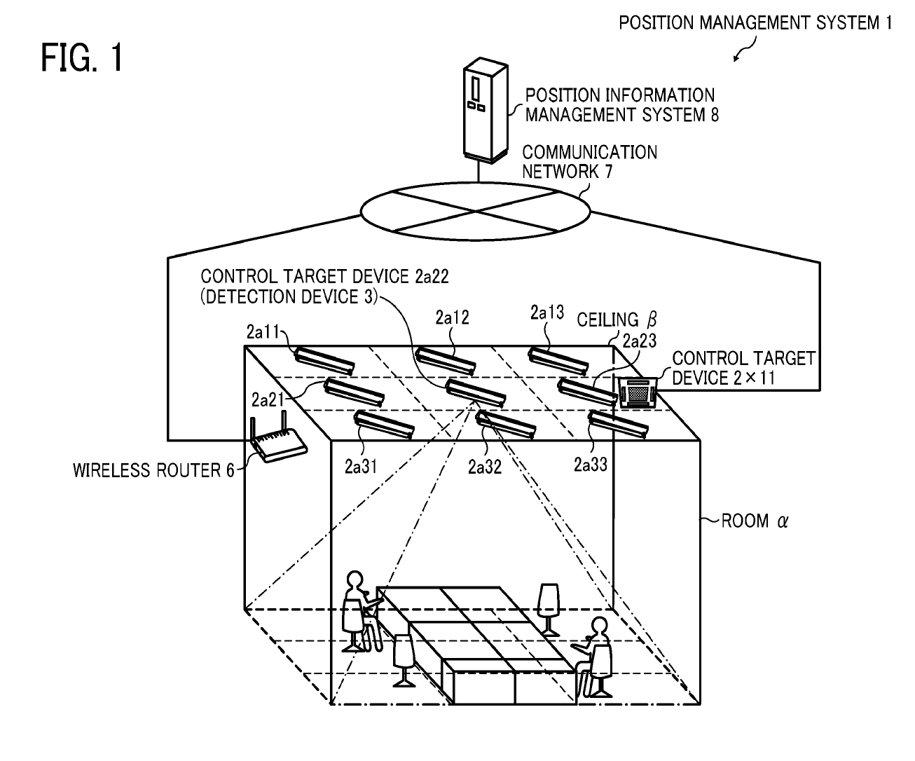

Referring to FIGS. 1 to 10, an embodiment of the present invention is described.

FIG. 1 is a schematic block diagram illustrating a configuration of a position management system according to the embodiment. As illustrated in FIG. 1, a position management system 1 in this embodiment includes multiple control target devices 2a11, 2a12, 2a13, 2a21, 2a22, 2a23, 2a31, 2a32, and 2a33, a control target device 2x11, a wireless router 6, and a position information management system 8, which are connected through a communication network 7. The control target devices 2a11, 2a12, 2a13, 2a21, 2a22, 2a23, 2a31, 2a32, and 2a33 are each disposed on a part of the ceiling β of an office room α, which is an example of a predetermined space.

In this embodiment, the part of the ceiling area is divided into nine areas. The control target devices 2a11, 2a12, 2a13, 2a21, 2a22, 2a23, 2a31, 2a32, and 2a33 are respectively located in the nine-partitioned areas of the part on the ceiling β. The control target device 2a22 in the center area includes a detection device 3. It should be noted that any one of the control target devices 2a11, 2a12, 2a13, 2a21, 2a22, 2a23, 2a31, 2a32, and 2a33 is referred to as “a control target device 2a” hereinafter. Further, in this example, one area corresponds to a square whose dimensions are 70 cm×70 cm.

The control target device 2a is a fluorescent-shaped light emitting diode (LED) lighting apparatus. The detection device in the control target device 2a22, which is provided with a thermopile, detects temperature distribution of the office room α that is partitioned into multiple areas (i.e., nine areas), and wirelessly transfers heat source data indicating whether the heat source exists in each area. The control target device 2x11 is an air-conditioner.

The wireless router 6 transfers the heat source data transferred from the detection device 3 to the position information management system 8 via the communication network 7. The communication network 7 may be implemented by a local area network (LAN), which may include the Internet.

The position information management system 8 generates control data for controlling the control target devices 2a and 2x, respectively, based on at least the heat source data transferred by the wireless router 6, and transfers the control data to the control target devices 2a and 2x, respectively. The control target device 2a controls a light level of the LED based on the control data. The control target device 2x11 controls temperature, humidity, air flow power, or air flow direction based on the control data. The control target device 2a22 not only detects the temperature distribution in the office room α with the detection device 3, but also controls the light level of the LED of its own based on the control data.

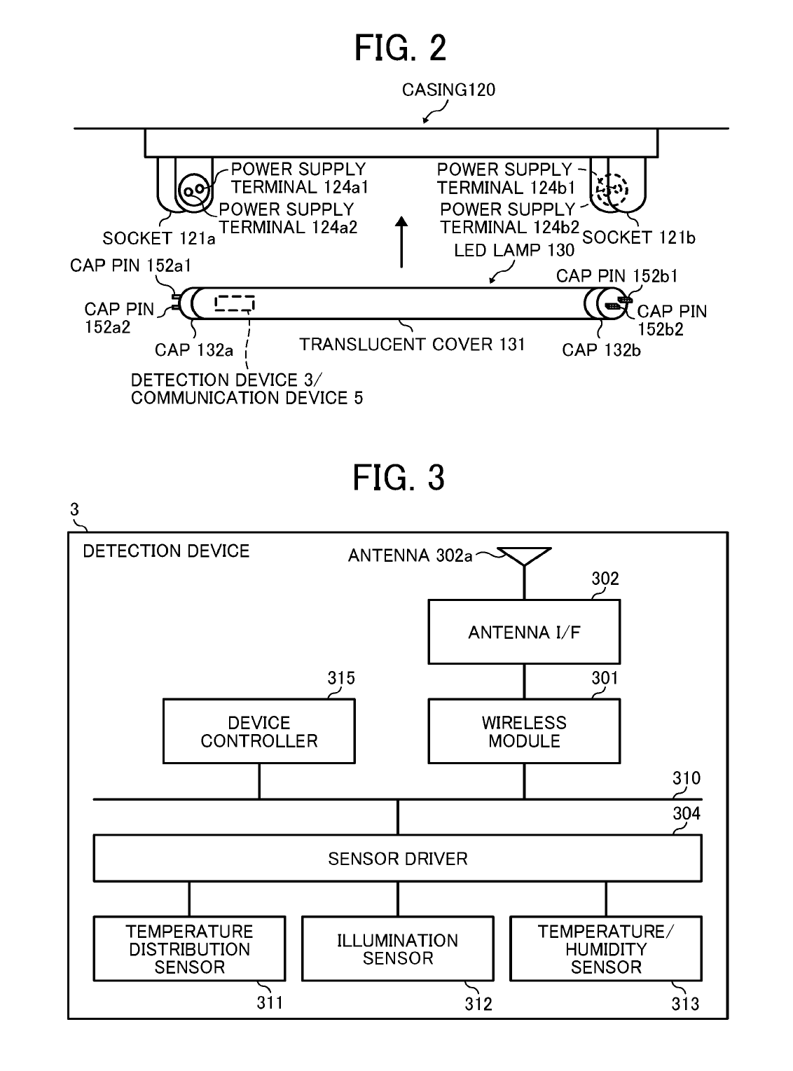

Next, a configuration of the control target device 2a and a casing on which the control target device 2a is mounted are described below with reference to FIG. 2. FIG. 2 illustrates an outer appearance of the control target device 2a, when the control target device 2a is implemented by the fluorescent LED lighting device according to an example embodiment of the present invention.

<Configuration of Control Target Device>

As illustrated in FIG. 2, the control target device 2a22 as the florescent LED lighting device is a straight tube lamp 130, and can be mounted on a casing 120 having a surface attached around the center of the ceiling β in the office room α in FIG. 1. The casing 120 has a socket 121a and a socket 121b at the respective ends. The socket 121a includes two power supply terminals 124a1 and 124a2, each of which supplies electric power to the LED lamp 130 when the LED lamp 130 is housed in the casing 120. The socket 121b includes two power supply terminals 124b1 and 124b2, each of which supplies electric power to the LED lamp 130 when the LED lamp 130 is housed in the casing 120. With these sockets, the casing 120 supplies electric power from a power supply to the LED lamp 130.

The LED lamp 130 includes a translucent cover 131, caps 132a and 132b that are provided at the respective ends of the translucent cover 131, and the detection device 3 placed inside the translucent cover 131. The translucent cover 131 may be made of, for example, resin material such as acrylic resin. The translucent cover 131 covers a light source, such as a LED module provided inside.

The cap 132a has cap pins 152a1 and 152a2, which are respectively connected to the power supply terminals 124a1 and 124a2 of the socket 121a. The cap 132b has cap pins 152b1 and 152b2, which are respectively connected to the power supply terminals 124b1 and 124b2 of the socket 121b. As the LED lamp 130 is housed inside the casing 120, electric power is supplied to each of the cap pins 152a1, 152a2, 152b1, and 152b2, via the power supply terminals 124a1, 124a2, 124b1, and 124b2 of the casing 120. The LED lamp 130 emits light outside through the translucent cover 131. The detection device 3 is operated with electric power supplied from the casing 120.

<Hardware Configuration of Position Management System>

Hardware configurations of the detection device 3 and the position information management system 8 are described below.

<Hardware Configuration of Detection Device>

The hardware configuration of the detection device 3 is described below with reference to FIG. 3. FIG. 3 is a schematic block diagram illustrating the hardware configuration of the detection device 3 as an embodiment of the present invention. The detection device 3 includes a wireless module 301, an antenna I/F 302, an antenna 302a, a sensor driver 304, a temperature distribution sensor 311, an illumination sensor 312, a temperature/humidity sensor 313, and a device controller 315, which are electrically connected through a bus line 310 such as an address bus or a data bus.

Among these components, the wireless module 301 communicates with one or more external apparatuses wirelessly via the antenna I/F 302 and the antenna 302a, in compliance with any desired communications protocol based on such as Bluetooth, Wi-Fi, or ZigBee standard. The communications protocol may not only be based on wireless communication but also based on wired communication using Ethernet or Power Line Communications (PLC). The wireless module 301 may operate under control of a communication control program.

The temperature distribution sensor 311 is, for example, a themopile sensor that detects temperature distribution in the office room α using infrared radiation.

The illumination sensor 312 detects brightness in the office room α. The temperature/humidity sensor 313 detects temperature and humidity in the office room α.

The sensor driver 304 drives the temperature distribution sensor 311, the illumination sensor 312, and the temperature/humidity sensor 313. The sensor driver 304 further generates heat source data that indicates whether or not a heat source exists based on the temperature distribution data output by the temperature distribution sensor 311. It should be noted that the sensor driver 304 can implement its function using software.

The device controller 315 controls operation of the control target device. When located inside the control target device 2, the device controller 315 may be implemented by a circuit that controls the light level of the LED. When located inside the control target device 2x11, the device controller 315 may be implemented by a circuit that controls air flow of the control target device 2X11 serving as the air conditioner. The circuit in this embodiment includes any programmed processor that operates under control of software, such as a detection control program stored in a memory such as a RAM. For the control target device 2a other than the control target device 2a22, the control target device 2a includes the wireless module 301, the antenna I/F 302, the antenna 302a, the bus line 310, and the device controller 315 among the configuration in FIG. 3. The control target device 2a other than the control target device 2a22 includes a communication device 5 capable of communicating with the position information management system 8.

<Hardware Configuration of Position Information Management System>

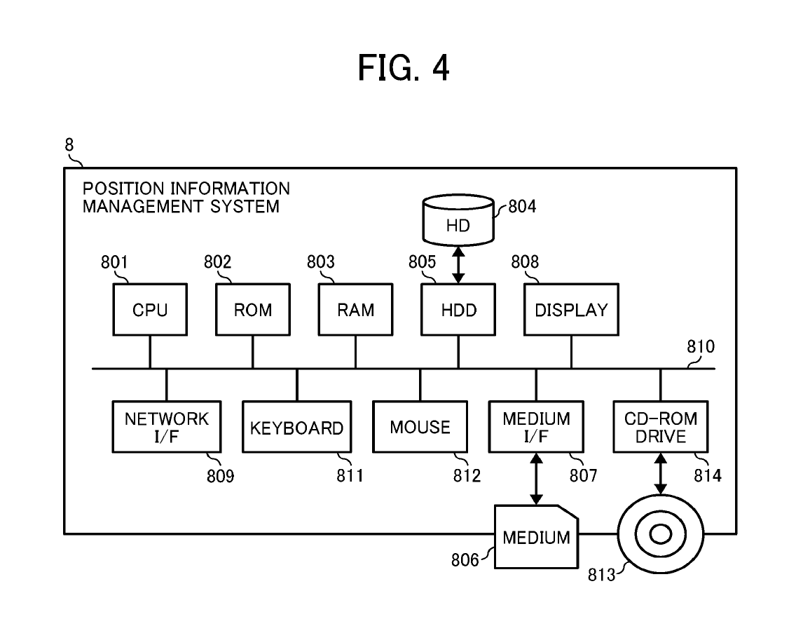

Next, a hardware configuration of the position information management system 8 is described below. FIG. 4 is a schematic block diagram illustrating a hardware configuration of the position information management system 8 in this embodiment.

The position information management system 8, in this example, is implemented by at least one computer. The position information management system 8 includes a CPU 801 that controls entire operation of the position information management system 8, a ROM 802 that stores a program such as an Initial Program Loader (IPL) used for driving the CPU 801, a RAM 803 that is used as a work area for the CPU 801, a hard disk (HD) 804 that stores various data such as a position information management program, a hard disk drive (HDD) 805 that controls reading/writing of various data from/to the HD 804 under control of the CPU 801, a medium I/F 807 that controls reading/writing data from/to a recording medium 806 such as a flash memory, a display 808 that displays various information such as a cursor, menu, window, text, and/or image, a network I/F 809 that allows communication of data using the communication network 7, a keyboard 811 that includes multiple keys for inputting texts, numeric values, or various commands, a mouse 812 that selects and executes various commands such as selection of a processing target or movement of the cursor, a Compact Disc Read Only Memory (CD-ROM) drive 814 that controls reading/writing various data from/to a CD-ROM 813 as an example of a removable recording medium, and a bus line 810 such as the address bus or the data bus that electrically connects the above-described components.

<Functional Configuration of Position Management System>

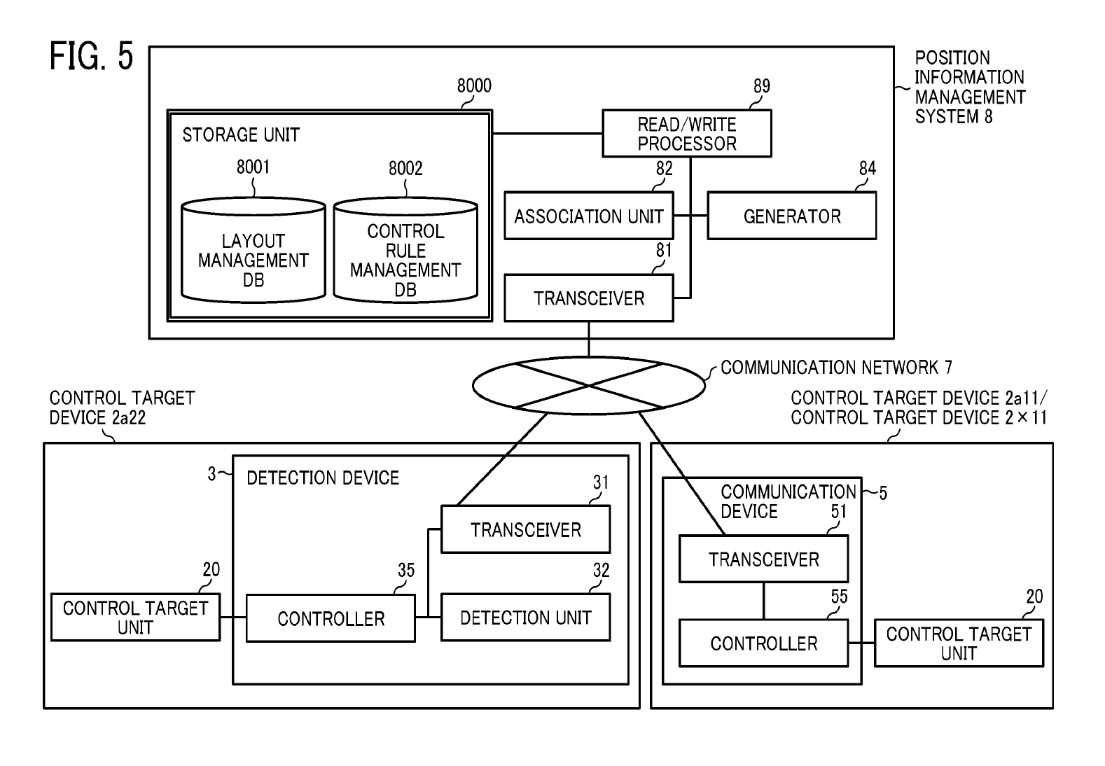

Referring now to FIG. 5, functional configurations of the control target device 2a22 including the detection device 3, the control target device 2a11 (2x), and the position information management system 8 are described according to the embodiment of the present invention. FIG. 5 is a schematic block diagram illustrating the functional configuration of the position management system 1 in this embodiment.

<Functional Configuration of the Control Target Device 2a22>

First, the functional configuration of the control target device 2a22 is described below. Those components are functional units that are implemented by operating under commands by the device controller 315 in accordance with the position information management program read from the memory. The control target device 2a22 includes the detection device 3 and the control target unit 20. Furthermore, the detection device 3 includes a transceiver 31, a detection unit 32, and a controller 35 as functional units. In this example where the control target device 2a22 is the LED lighting apparatus, the control target unit 20 is the LED lamp 130 that outputs light under control of the position information management system 8.

The transceiver 31 in the detection device 3 is implemented by the wireless module 301. For example, the transceiver 31 exchanges data with the position information management system 8 via the communication network 2.

The detection unit 32 is implemented by the sensors 311, 312, and 313. For example, the detection unit 32 detects temperature distribution at each area of the partitioned areas in the predetermined space with the temperature distribution sensor 311.

The controller 35 is implemented by the device controller 315. For example, the controller 35 generates a control signal to be output to the control target unit 20 based on control data transferred by the position information management system 8.

<Functional Configuration of the Control Target Device>

Next, a functional configuration of the control target device 2a11 is described below. The control target device 2a11 includes the communication device 5 and the control target unit 20. Furthermore, the communication device 5 includes a transceiver 51 and a controller 55. In the example case where the control target device 2a11 is the LED lighting apparatus, the control target unit 20 is the LED to be controlled by the position information management system 8. In the example case where the control target device 2x11 is the air conditioner, the control target unit 20 is a compressor etc. of the air conditioner that adjusts temperature, humidity, air flow power, and air flow direction under control of the position information management system 8.

The transceiver 51 in the communication device 5 is implemented by the wireless module 301. Since the transceiver 51 is similar in function to the transceiver 31 described above, its description is omitted.

The controller 55 is implemented by the device controller 315. Since the controller 55 is similar in function to the controller 35 described above, its description is omitted.

<Functional Configuration of Position Information Management System>

Next, a functional configuration of the position information management system 8 is described below. The position information management system 8 includes a transceiver 81, an association unit 82, a generator 84, and a read/write processor 89. Those components are functional units that are implemented by operating under commands by the CPU 801 in accordance with the position information management program read from the HD 804 into the RAM 803. Furthermore, the position information management system 8 includes a storage unit 8000, which may be implemented by the RANI 803 and/or the HD 804 in FIG. 4. The storage unit 8000 stores therein a layout management database (DB) 8001 and a control rule management DB 8002.

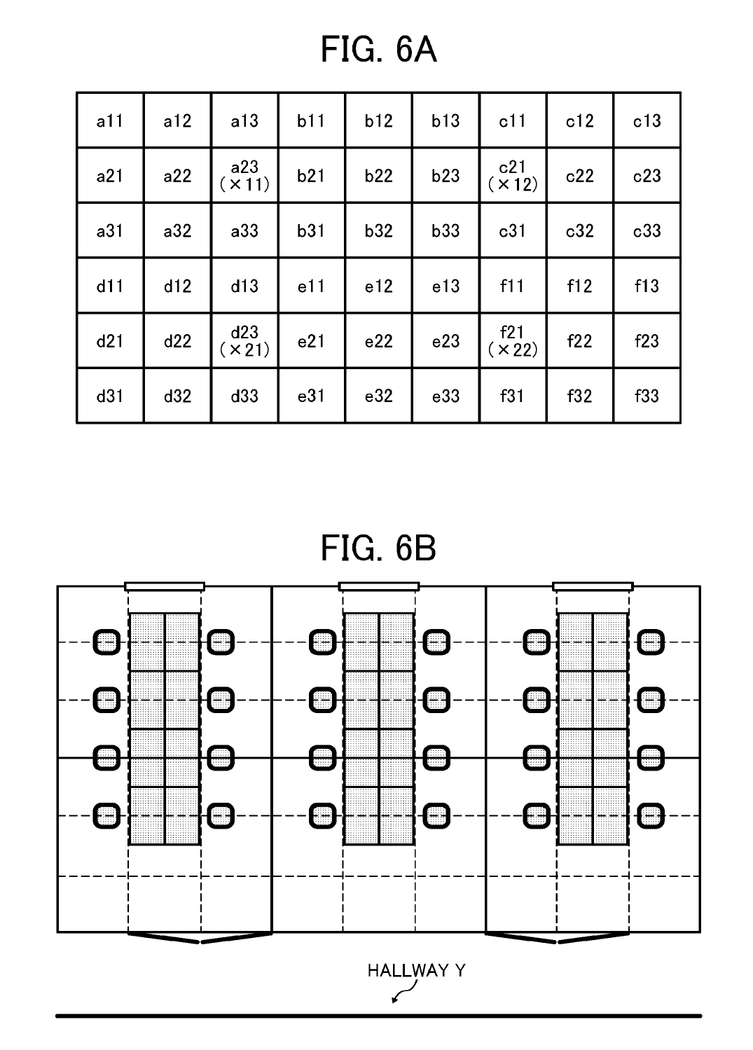

Next, the layout management DB 8001 is described below with reference to FIGS. 6A and 6B. The layout management DB 8001 stores layout information of the control target devices as shown in FIG. 6A. FIG. 6A is a conceptual diagram illustrating layout information of the control target device, and FIG. 6B is a diagram illustrating layout information of the office room. Areas in the layout information in FIG. 6A indicate areas partitioned by broken lines or solid lines on the layout of the office room α shown in FIG. 6B.

As shown in FIG. 6A, in the layout information of the control target devices, the office room α is partitioned into 54 areas. For each partitioned area, a device ID for identifying a specific control target device (such as the LED lighting apparatus) present in that area is assigned. The layout information of FIG. 6A thus manages association between the partitioned area and the device ID in that area. Among these areas, the upper left block whose device IDs start with “a” corresponds to 9 areas in FIG. 1. That is, FIG. 1 illustrates a part of the office room α illustrated in FIG. 6A and 6B, and the office room α is partitioned into 6 blocks whose device IDs start with a, b, c, d, e, and f, respectively. Furthermore, each of the blocks is partitioned into 9 areas, thus partitioning the office room α into 54 areas in total. The partitioning described above is just an example, and the office room may be partitioned into any desired number of blocks. Similarly, it is possible to partition one block into a number of areas other than nine.

In FIG. 6A, the device IDs x11, x12, x21, and x22 are device IDs for identifying control target devices 2x11, 2x12, 2x21, and 2x22 as the air conditioners. The control target devices 2x12, 2x21, and 2x22 (not shown in FIG. 1) are disposed at respective locations on the ceiling β indicated by x12, x21, and x22 in FIG. 6A. That is, four air conditioners are mounted on the ceiling β in the office room α. It should be noted that any one of the control target devices 2x11, 2x12, 2x21, and 2x22 may be referred to as “a control target device 2x” hereinafter.

FIG. 6B illustrates a layout of desks and chairs in the office room α. In FIG. 6B, the office room is partitioned into 54 areas as indicated by the layout information in FIG. 6A. That is, positions of areas in FIG. 6B respectively correspond to positions of areas in FIG. 6A. In FIG. 6B, the lower side indicates a hallway y, and the upper side indicates the window.

(Control Rule Management DB)

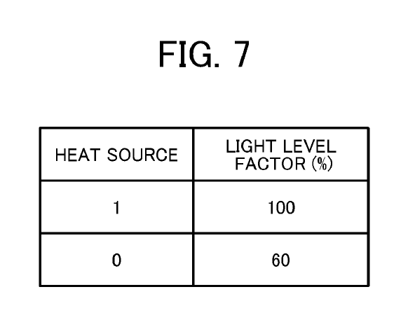

Next, the control rule management DB 8002 is described below with reference to FIG. 7. In the control rule management DB, a control rule management table shown in FIG. 7 is managed. The control rule management table stores, control contents of the control target unit 20 in association with heat source presence information. For example, if the heat source presence information is “1” indicating that the heat source exists, that is, human exists in the area, the light level factor is set at 100% to maximize LED's light level. By contrast, if the heat source presence information is “0” indicating that the heat source does not exist, that is, human does not exist in the area, the light level factor is set at 60% to reduce light level of the LED to save energy. In this case, values 100% and 60% are examples, and any values work as long as the light level factor for the heat source “1” is higher than the light level factor for the heat source “0”, such as values 90% for the heat source “1” and 50% for the heat source “0”.

(Functional Configuration of Position Information Management System)

Next, a functional configuration of the position information management system 8 is described below with reference to FIG. 5, according to the embodiment of the present invention.

The transceiver 81 in FIG. 5 receives detection data from the detection device 3 or transfers control data to the detection device 3.

The association unit 82 refers to layout information in FIG. 6A (described later) and heat source data in FIG. 10 (described later).

For example, the generator 34 generates heat data that indicates existence or nonexistence of heat source based on the temperature distribution data. For example, the generator 84 generates control data that indicates a light level factor to the control target devices 2a and 2x.

The read/write processor 89 reads data from the storage unit 8000 or stores data in the storage unit 8000.

<Operation of the Position Management System>

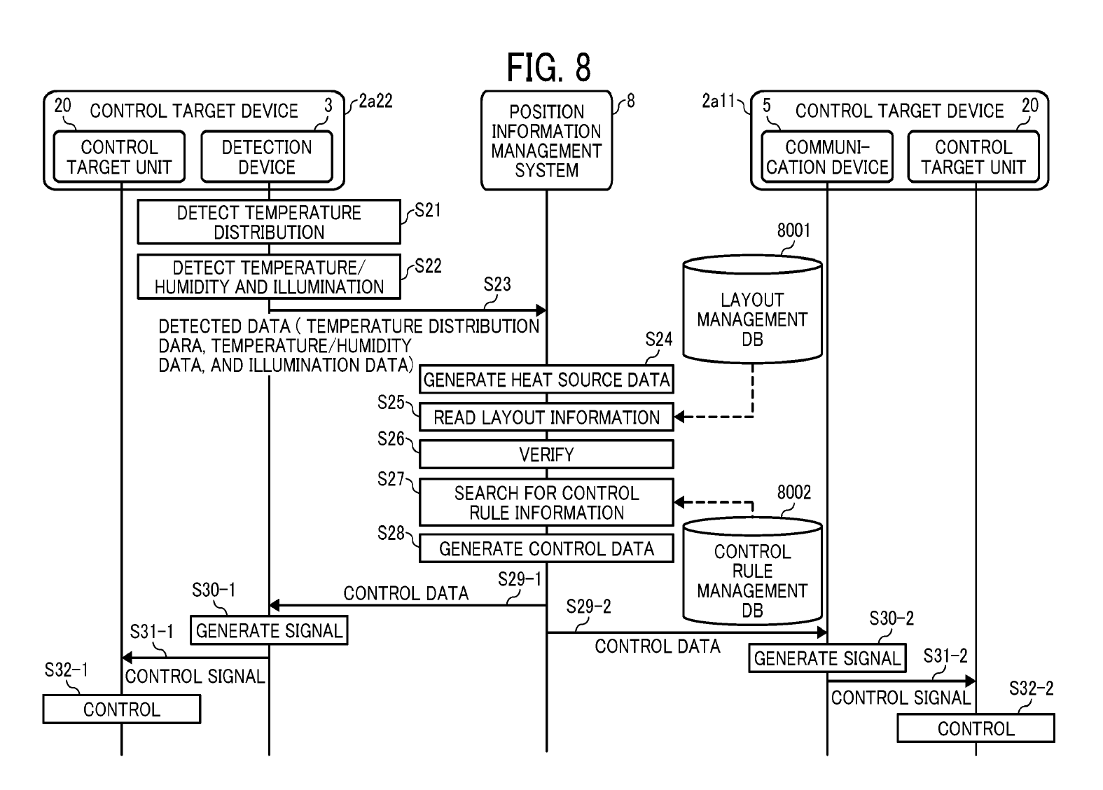

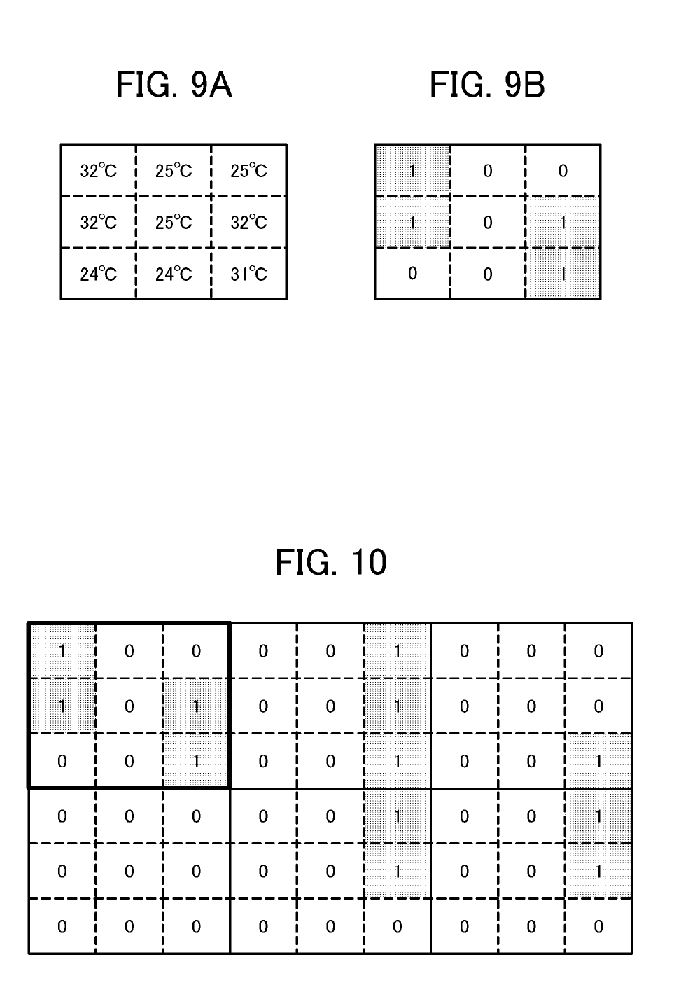

Operation of the position management system is described below with reference to FIGS. 8 to 10. FIG. 8 is a sequence diagram illustrating a process executed by the position management system 1 in this embodiment. FIG. 9A is a conceptual diagram illustrating temperature distribution, and FIG. 9B is a diagram illustrating heat source data that indicates whether a heat source exists. FIG. 10 is a diagram illustrating the heat source data that indicates whether a heat source exists for each area in one office room.

In this example operation, it is assumed that the position information management system 8 generates the control data for controlling the control target devices 2a and 2x based on various data detected by the control target device 2a22 and transfers the control data to the control target devices 2a and 2x to respectively control light level and quantity of air etc. of the control target devices 2a and 2x. To simplify the description, among the control target devices 2a, a process executed by the control target device 2a22 that includes the detection device 3 and the control target device 2a11 that includes the communication device 5 is described below.

First, as shown in FIG. 8, the detection unit 32 in the control target device 2a22 detects temperature distribution at each area in the office room α in S21. In addition, the detection unit 32 in the control target device 2a22 detects illumination, temperature, and humidity around the control target device 2a22 in S22. Subsequently, the transceiver 31 transfers detection data to the position information management system 8 in S23. The detection data includes the temperature distribution data that indicates the detection result in S21 and the temperature/humidity data and illumination data that indicates the detection result in S22. Accordingly, the transceiver 81 in the position information management system 8 receives the detection data.

Next, the generator 84 in the position information management system 8 generates heat source data based on the temperature distribution data in S24. Here, generation of the heat source data is described below with reference to FIG. 9. After the detection unit 32 in the detection device 3 detects temperature at each area, in case of acquiring temperature distribution in nine areas as shown in FIG. 9A, the generator 84 in the position information management system 8 generates heat source data in FIG. 9B. That is, the heat data is shown by heat source existence information indicating whether or not the heat source exists, i.e., an area whose temperature is equal to or more than 30° C. is indicated as “1”, and an area whose temperature is less than 30° C. is indicated as “0”. In addition, in S24, the generator 84 synthesizes the heat source data generated based on the temperature distribution data sent from each block. FIG. 10 illustrates the synthesized data. FIG. 10 is a diagram illustrating the heat source data that indicates whether or not heat source exists for all heat sources in one office room. For example, the heat source data in FIG. 9B corresponds to the upper left first block in FIG. 10.

Next, the read/write processor 59 in the position information management system 8 reads the layout information in FIG. 6A from the layout management DB 8001 in S25. Subsequently, the association unit 82 refers to the layout information in FIG. 6A and the heat source data in FIG. 9B in S26 to determine whether the heat source exists in each area. For example, the association unit 82 refers to the location “a11” of the control target device in the layout information and the value “1” of the heat source data, to determine that the heat source exists at the location “a11”.

Next, the read/write processor 59 in the position information management system 8 searches, for each area, the control rule management DB 8002 using “1” or “0” of the heat source data indicating whether the heat source exists as a retrieval key to read the corresponding light level factor in S27. Accordingly, the generator 84 generates control data that indicates the light level factor for each area, to be transmitted to the control target device 2a in each area in S28. More specifically, as illustrated in FIG. 8, the generator 84 generates control data indicating the light level factor to be transmitted to the control target device 2a11. In case of the control target device 2a as the LED lighting apparatus at other 53 areas, the generator 84 generates control data that indicates each light level factor similarly. In case of the control target device 2x as the air conditioner, the generator 84 generates control data that indicates, for example, characteristics of air flow for the control target device 2x.

Next, the transceiver 51 transfers each of the control data to the control target devices 2a22 and 2a11 in S29-1 and S29-2, respectively. Subsequently, the transceiver 31 in the detection device 3 in the control target device 2a22 receives the control data. Likewise, the transceiver 51 in the communication device 5 in the control target device 2a11 receives the control data.

Next, in the control target device 2a22, the controller 35 in the detection device 3 generates a control signal to be output to the controlled unit 20 as the LED lamp based on the control data in S30-1 and outputs the control signal to the controlled unit 20 in S31-1. As a result, amount of light of the controlled unit 20 as the LED lamp is controlled. Similarly, in the control target device 2a11, the controller 55 in the communication device 5 generates a control signal to be output to the controlled unit 20 as the LED lamp based on the control data in S30-2 and outputs the control signal to the controlled unit 20 in S31-2. As a result, amount of light of the controlled unit 20 as the LED lamp is controlled. For example, referring to FIG. 9B, the area beneath the control target device 2a22 has the value “0” indicating that there is no heat source. Therefore, regarding the control content of the control target device 2a22, the light level factor is set to “60%” in accordance with the rule table of FIG. 7. By contrast, referring to FIG. 9B, the area beneath the control target device 2a11 has the value “1” indicating that there is a heat source. Therefore, regarding the control content of the control target device 2a11, the light level factor is set to “100%” in accordance with the rule table of FIG. 7. Accordingly, if a heat source is detected due to existence of human, the light level of the LED is maximized. If a heat source is not detected due to nonexistence of human, the light level of the LED is reduced. As a result, it is possible to save energy.

The operation of FIG. 8 is performed in a substantially similar manner for the rest of areas in the office room. For example, in case of the control target device 2a as the LED lighting apparatus at other areas in the other blocks, the generator 84 generates control data that indicates each light level factor similarly.

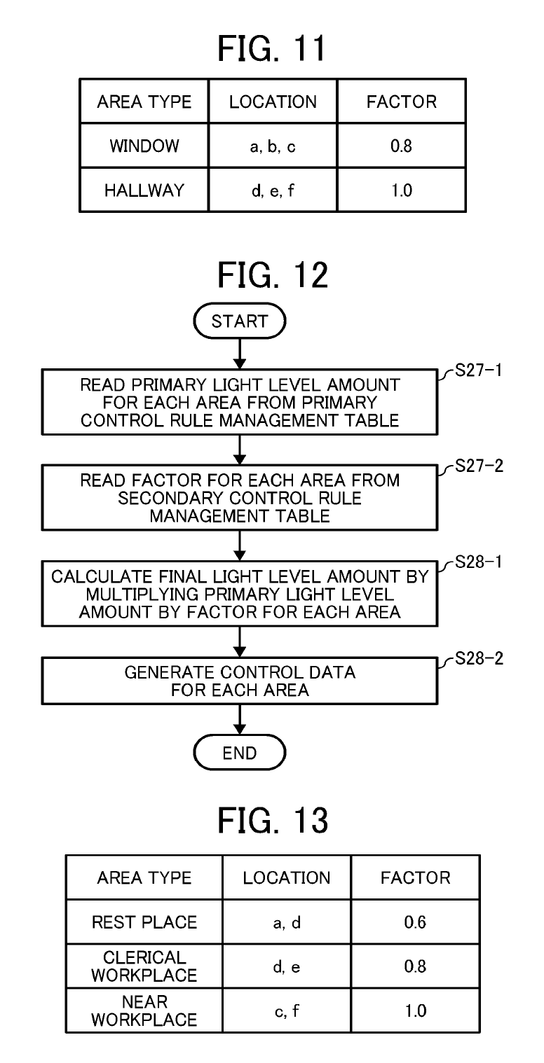

Embodiments of the present invention are described below with reference to FIGS. 11 to 13 specifically. Here, two examples in steps S27 and S28 in FIG. 8 are described.

The first example is described below with reference to FIGS. 11, 12A and 12B. FIG. 11 is a conceptual diagram illustrating a control rule management table in this example. A table in FIG. 7 is an example of a primary control rule management table (first control rule management table) used for calculating a primary light level factor, and a table in FIG. 11 is an example of a secondary control rule management table (second control rule management table) used for modifying the primary light level factor in accordance with a type of area to obtain a secondary primary light level factor. The control rule management DB 8002 stores the fundamental control rule management table in FIG. 7 and the applied control rule management table in FIG. 11.

The secondary control rule management table in FIG. 11 stores, for each type area indicating a type of an area, position information of the area and adjustment information (e.g. a factor) to be used for adjusting the primary light level factor in association with one another. The adjustment information is in this example a factor to be multiplied with the primary light level factor. For example, if the type of an area is “window”, positions of the “window” area can be identified with symbols “a”, “b”, and “c”, each of which is the first letter of the device ID of the control target device, as illustrated in layout information of the control target device in FIG. 6A. For each of these window areas, a factor “0.8” is multiplied with the primary light level factor to obtain a secondary light level factor. This factor is previously determined based on assumption that the window side is brighter than the hallway side.

Next, operation in this example is described below with reference to FIG. 12. FIG. 12 is a flowchart illustrating a process of calculating a light level factor for each control target device in this example. In FIG. 12, a process in steps S27-1 and S27-2 is illustrated so that the process of S27 of FIG. 8 can be described in detail, and a process in steps S28-1 and S28-2 is illustrated so that the process of S27 of FIG. 8 can be described in detail.

First, the read/write processor 89 in the position information management system 8 searches, for each area, the primary control rule management table in FIG. 7 using “1” or “0” of the heat source data indicating whether or not the heat source exists, which is received in S23 as a retrieval key to read the corresponding light level factor in S27-1. In addition, the read/write processor 89 searches, for each area, the secondary control rule management table in FIG. 11 using the symbol “a” etc. of the device ID in FIG. 6A as a retrieval key to read the corresponding light level factor in S27-2.

Next, the generator 84 calculates a light level factor to be used for each area by multiplying the primary light level factor read in S27-1 by the factor read in S27-2 in S28-1. Subsequently, the generator 84 generates control data for each area using the calculation result in S28-1, in S28-2.

While types of area is determined based on layout in the secondary control rule management table, it is not limited to this example. It is also possible to define types of area based on layout and time zones. For example, it is possible to determine each factor every three hours.

As described above, in this example, it is possible to control the light level factor with improved accuracy, while considering not only the existence of human but also layout of the office room such as whether the specific area is the window side or the hallway side. As a result, it is possible to save energy while taking into account the actual condition.

The second example is described below with reference to FIG. 13. FIG. 13 is a conceptual diagram illustrating a control rule management table in this example. A table in FIG. 13 is another example of a secondary control rule management table (second control rule management table) used for modifying the primary light level factor in accordance with a type of area. The control rule management DB 8002 stores the primary control rule management table in FIG. 7 and the secondary control rule management table in FIG. 13.

While the applied control rule management table in FIG. 13 has the same structure as the applied control rule management table in FIG. 11, managed attributes are different. That is, in the first example, the light level factor is determined considering the layout that reflects the level of sunlight at a specific position as the element. By contrast, in the second example, the light level factor is determined considering content of office work. In FIG. 13, rest place where a person can relax, clerical work place where a person does regular office work, and near work place where a person does near work requiring preciseness are managed as types of area. In this case, the whole office room α is divided into three parts, and the left part is the rest place, the center part is the clerical work place, and the right part is the near work place. Since it is possible to dim the rest place, the factor is set to “0.6”. Since it is preferable to keep the clerical work place brighter compared to the rest place, the factor is set to “0.8”. Since it is desired to keep the near work place the brightest, the factor is set to “1”.

Since the operation in this example is similar to the operation in the first example described above, its description is omitted. It is also possible to use the secondary control management table in the first example combining with the secondary control management table in the second example.

As described above, in this example, it is possible to control the light level factor with improved accuracy, while considering not only the existence of human but also content of office work such as precision required for the office work. As a result, it is possible to save energy more appropriately, while considering the actual condition.

Numerous additional modifications and variations are possible in light of the above teachings. It is therefore to be understood that, within the scope of the appended claims, the disclosure of this patent specification may be practiced otherwise than as specifically described herein.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a Wireless Application Protocol (WAP) or 3G-compliant phone) and so on. Since the present invention can be implemented as software, each and every aspect of the present invention thus encompasses computer software implementable on a programmable device.

The computer software can be provided to the programmable device using any storage medium or carrier medium for storing processor-readable code such as a floppy disk, a compact disk read only memory (CD-ROM), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a solid state memory device or the like, but not limited these. The hardware platform includes any desired kind of hardware resources including, for example, a central processing unit (CPU), a random access memory (RAM), and a hard disk drive (HDD). It is also possible to download the program from an external apparatus that includes a storage medium storing the program or stores the program in a storage unit and install the program in the computer to execute the program. The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C++, Java (registered trademark), JavaScript (registered trademark), Perl, Ruby, or legacy programming languages such as machine language, assembler language to control functional units used for the apparatus or system. For example, a particular computer (e.g., personal computer, workstation) may control an information processing apparatus or an image processing apparatus such as image forming apparatus using a computer-readable program, which can execute the above-described processes or steps. In the above-described embodiments, at least one or more of the units of apparatus can be implemented as hardware or as a combination of hardware/software combination.

Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

1. A system for controlling one or more control target units in a predetermined space, the system comprising:
a first control rule management unit to manage heat source existence information indicating whether a heat source exists at a specific area in the predetermined space and a control item of the control target unit in the predetermined space associating with each other;
a second control rule management unit to manage, for each area of the predetermined space, position information indicating a position of the area and adjustment information to be used for adjusting the control item associating with each other;
a receiver to receive detection data indicating a temperature at each of multiple areas in the predetermined space;
a first generator to generate heat source data including heat source existence information indicating whether a heat source exists for each of the multiple areas based on the detection data;
a second generator to obtain a control item of the control target using the heat source existence information for each of the multiple areas from the first control rule management unit, obtain adjustment information for each of the multiple areas using position information of each area from the second control rule management unit, and generate control data indicating a modified control item for each of the multiple areas based on the obtained control item and the obtained adjustment information; and
a transmitter to transfer the control data generated by the second generator to one or more apparatuses each controlling the control target unit.

2. The position information management system according to claim 1, wherein, when the control target unit is a light, the control item indicates a light level factor of the light.

3. The position information management system according to claim 2, wherein
the position information indicates whether the area is a window side or a hallway side if the predetermined space is a room, and
the adjustment information indicates that the light level factor of the light is near to a maximum value if the position information indicates that the area is a hallway side compared to the adjustment information whose position information indicates a window side.

4. The position information management system according to claim 2, wherein
the position information indicates that the area is at least one of a near work place, a clerical work place, and a rest place if the predetermined space is a room, and
the adjustment information indicates that the light level factor of the light decrease from a maximum value in order from the near work place, the clerical work place, and the rest place.

5. The position information management system according to claim 2, wherein the light is a LED.

6. A position management system, comprising:
the position information management system according to claim 1; and
a detection device that outputs the detection data.

7. A method of controlling one or more control target units in a predetermined space, the method comprising:
storing in a memory heat source existence information indicating whether a heat source exists at a specific area in the predetermined space and a control item of the control target unit in the predetermined space associating with each other;
storing in the memory, for each area of the predetermined space, position information indicating a position in the area and adjustment information to be used for adjusting the control item associating with each other;
receiving detection data indicating a temperature at each of multiple areas in the predetermined space;
generating heat source data including heat source existence information indicating whether a heat source exists for each of the multiple areas based on the detection data;
obtaining a control item of the control target using the heat source existence information for each of the multiple areas from the first control rule management unit;
obtaining adjustment information for each of the multiple areas using position information of each area from the second control rule management unit;
generating control data indicating a modified control item for each of the multiple areas based on the obtained control item and the obtained adjustment information; and
transferring the generated control data to one or more apparatuses each controlling the control target unit.

8. A non-transitory, computer-readable recording medium storing a program that, when executed by one or more processors, causes the processors to implement a method of controlling one or more control target units in a predetermined space, comprising:
storing in a memory heat source existence information indicating whether a heat source exists at a specific area in the predetermined space and a control item of the control target unit in the predetermined space associating with each other;
storing in the memory, for each area of the predetermined space, position information indicating a position in the area and adjustment information to be used for adjusting the control item associating with each other;
receiving detection data indicating a temperature at each of multiple areas in the predetermined space;
generating heat source data including heat source existence information indicating whether a heat source exists for each of the multiple areas based on the detection data;
obtaining a control item of the control target using the heat source existence information for each of the multiple areas from the first control rule management unit;
obtaining adjustment information for each of the multiple areas using position information of each area from the second control rule management unit;
generating control data indicating a modified control item for each of the multiple areas based on the obtained control item and the obtained adjustment information; and
transferring the generated control data to one or more apparatuses each controlling the control target unit.
